(19) United States
(12) Patent Application Publication
(10) Pub. No.: US 2025/0257943 A1
(43) Pub. Date: Aug. 14, 2025

(54) METHOD FOR DRYING FLEXOGRAPHIC PLATES AND OVEN FOR IMPLEMENTING SAID METHOD

(71) Applicant: Vianord Engineering Sasu, Carros (FR)

(72) Inventor: Pier Luigi Sassanelli, Cagnes-sur-Mer (FR)

(21) Appl. No.: 19/052,078

(22) Filed: Feb. 12, 2025

(30) Foreign Application Priority Data
Feb. 14, 2024 (IT) 102024000003145

(51) Int. Cl. F26B 9/06; B41C 1/18; F26B 3/04

(52) U.S. Cl. CPC F26B 9/066; B41C 1/18; F26B 3/04

(57) ABSTRACT

A method for controlling an oven for drying flexographic plates, comprising: activating thermal energy generation means and air circulation means of a first drawer module of the oven, until the temperature of the first drawer module reaches a stand-by value; inserting a flexographic plate into a first drawer of the first drawer module; increasing the temperature of the first drawer module from the stand-by value to a drying value; inserting a flexographic plate into a second drawer of the first drawer module; activating the thermal energy generation means and the air circulation means in a second drawer of the oven, until the temperature of such second drawer reaches a stand-by value; inserting a flexographic plate into a first drawer of the second drawer module; increasing the temperature of the second drawer from the stand-by value to a drying value.

### CROSS-REFERENCES TO RELATED APPLICATIONS

This application claims benefit of Italian Patent Application No. 102024000003145, filed Feb. 14, 2024, and which is hereby incorporated by reference.

### TECHNICAL FIELD

The present disclosure relates, in general, to the technical field of systems for the preparation of digital printing plates for flexography. In particular, the present disclosure relates to a method for drying flexographic plates and to an oven for drying flexographic plates configured to implement such method.

### BACKGROUND

Flexography is a direct rotary printing method used, for example, for making paper or plastic bags, milk cartons, disposable cups, and similar products. Flexography is also used for printing newspapers, envelopes, labels, films, acetate sheets, wrapping paper, and many materials used in product packaging.

Flexography uses relief plates, which are made from photopolymer materials. The plates are flexible and soft, hence the term flexography. Flexographic plates are inked, and printing is achieved by direct deposition of the ink on the substrate to be printed, which is achieved by means of a light pressure exerted by a printing cylinder on which the plates are positioned.

A particular flexographic printing process is “digital flexography”, which involves the use of digital flexographic plates. In such plates, the photopolymer is originally covered by a surface layer of material that does not allow photo-exposure, such as a thin layer of carbon or graphite. This surface layer is engraved to create a negative image of the subject of the print. The engraving step is typically carried out using a digital laser, controlled by a computer (hence the acronym CTP, “computer to plate”, which is used in the field to designate this step of the pre-printing process). The plate is then photo-exposed to ultraviolet rays, in order to harden the part in question, that is, the one engraved by the laser. The material not exposed to light is eliminated through a washing operation, which is carried out at a washing station in the system, also known in the field as a “developer” station. After washing, the plate will have a relief part, which will then be used to transfer the printing ink onto the substrate (paper, plastic, etc.).

Washing the plate is typically done with a solvent-based washing solution, which dissolves the polymer or monomer. Alternatively, the washing solution may also be water-based. The use of one type of washing solution or another depends on the nature of the flexographic plate used. In any case, the washing operation involves immersing the plates in the washing solution and using brushes, which exert a mechanical action on the surface of the plate, promoting the detachment of the monomer or polymer previously not exposed to light and producing a relief image on the polymerized part of the plate. The scrubbing action starts at the surface of the plate and gradually proceeds downwards into the plate, until the full depth of the relief is reached. The unexposed polymer is completely removed by the combined action of the brush and the washing solution.

Typically, flat flexographic plates are washed using washing stations provided with a chamber, inside which a movement plane is defined along which the plate is advanced. Inside the chamber there are also hydraulic terminals, which carry the washing solution to the washing brushes.

During washing, the flexographic plate absorbs some of the washing solution and swells. Swelling increases the longer the plate remains in contact with the washing solution. It follows that the longer the washing time, the greater the amount of washing solution absorbed by the plate.

Several factors influence the washing time, and thus the amount of washing solution absorbed by the plate, including: thickness of the original plate (raw material); chemical composition of the plate (chemical formulation); type of equipment used for washing (washing system); contact pressure of the brushes (distance between the brushes and the plate sliding plane); chemical composition of the washing solution; contamination level of the washing solution (amount of monomer present in the washing solution); depth of relief to be obtained (height of the print character from the bottom of the plate); and temperature of the washing solution (optimum temperature of the washing solution effective for removal of the unexposed polymer).

In order to use the flexographic plate in printing, it must have a uniform and perfectly calibrated thickness. It follows that, after the washing operation, the plate must be perfectly dried and have a thickness exactly equal to the original one.

The drying process is carried out inside forced air ovens, which operate at a temperature no higher than 60° C. (140° F.)±5° C., so as not to deform the Mylar® base of the sheet. The ovens must also be able to evacuate the fumes produced during the drying of plates washed with solvent-based solutions.

Proper drying of flexographic plates is particularly important to ensure maximum results in the case of four-color or polychrome work and high levels of resolution, tonal reproduction and register. Furthermore, drying is slow and therefore, when compared to all other steps of the flexographic plate production process, it turns out to be the “bottleneck” of the entire production process.

At the end of the drying process, the surface of the sheet is sticky and therefore, to complete the processing of the sheet, a further step is necessary, during which the sheet is irradiated by UVA and UVC ray lamps.

The ovens for drying flexographic plates currently on the market typically comprise a series of metal drawer modules, in which the plates are placed in sequence after washing. Each drawer module usually includes a pair of drawers, which are typically operated simultaneously, and the number of drawer modules may range from a minimum of two (four drawers) to a maximum of five (ten drawers) depending on the oven model used.

The heating of the air inside the drawers occurs by means of thermal energy generators, in the form of quartz electrical resistors, while, inside each pair of drawers, uniform temperature distribution is achieved using air circulation means, in the form of tangential fans. The vapours of the washing solution, which are generated inside the oven during the drying process of the plates, are conveyed outside the oven using an exhaust duct common to all the drawers. Finally, the air saturated with the vapours of the washing solution is discharged from the oven using an air suction means, in fluid communication with the exhaust duct.

The known ovens for drying flexographic plates described above, however, have some drawbacks linked to the fact that, when switched on, the electrical resistors and tangential fans are activated simultaneously for all the drawers, in order to bring the temperature of the drawers to a value (working temperature) necessary for drying the flexographic plates. Furthermore, when switched on, the air suction means common to all drawers is also activated.

Such a solution, although currently accepted by the market, actually has an unfavourable impact on the operating costs for the production of flexographic plates. Furthermore, the aforementioned solution, by heavily engaging all the oven components, generates significant maintenance costs.

### SUMMARY

A primary task of the present disclosure is to provide a method for drying flexographic plates, and a corresponding oven, which can overcome the above-mentioned drawbacks with reference to known types of ovens for drying flexographic plates. Within this task, an object is to provide a method for controlling an oven for drying flexographic plates, and a corresponding oven, which allow the electrical energy consumption for drying the flexographic plates to be minimized, both during oven downtime and during the actual drying.

Another object of the present disclosure is to provide a method for drying flexographic plates, and a corresponding oven, which allow the functionality of the active components of the oven to be preserved, thus delaying the failure and relative replacement thereof.

Last but not least, an object of the present disclosure is to provide a method for drying photographic plates, and a related oven, which may achieve drying results comparable to those obtained with traditional ovens and drying methods, and at the same time are more reliable and can be easily implemented or produced at competitive costs.

In a first aspect thereof, a method is disclosed herein for drying flexographic plates by means of an oven comprising at least two drawer modules, each comprising a respective heating unit that includes thermal energy generation means and air circulation means; such method comprises the steps of:
S1) activating the thermal energy generation means and the air circulation means of a first drawer module of the oven, until the temperature of the first drawer module reaches an inactivity or stand-by value;
S2) inserting a flexographic plate into a first drawer of the first drawer module;
S3) increasing the temperature of the first drawer module from the stand-by value to a drying or working value;
S4) inserting a flexographic plate into each drawer of the first drawer module subsequent to the first drawer until all drawers of the first drawer module are filled;
S5) activating, after a predetermined number of drawers of the first drawer module has been filled, the thermal energy generation means and the air circulation means of a second drawer module of the oven until the temperature of the second drawer module reaches a stand-by value;
S6) inserting a flexographic plate into a first drawer of the first drawer module;
S7) increasing the temperature of the second drawer module from the stand-by value to a drying value.

In a second aspect thereof, the present disclosure relates to an oven for drying flexographic plates comprising at least two drawer modules, each provided with a respective heating unit which includes thermal energy generation means, air circulation means and an electronic control unit, in electrical communication with the thermal energy generation means and with the air circulation means. The oven as disclosed herein may be characterised in that the electronic control unit is configured to:
a1) activate the thermal energy generation means and the air circulation of a first drawer module of the oven, until the temperature of the first drawer module reaches a stand-by value;
a2) determine the achieved insertion of a flexographic plate in a first drawer of the first drawer module;
a3) activate the generation means of the first drawer module so as to increase the temperature of the first drawer module from the stand-by value to a drying value;
a4) determine the achieved insertion of a flexographic plate for each drawer of the first drawer module;
a5) activate, following the determination of the achieved insertion of a flexography plate in a predetermined number of drawers of the first drawer module, the thermal energy generation means and the air circulation means of a second drawer module of the oven until the temperature of the second drawer module reaches a stand-by value;
a6) determine the achieved insertion of a flexographic plate in a first drawer of the second drawer module;
a7) activate the thermal energy generation means of the second drawer module so as to increase the temperature of the second drawer module from the stand-by value to a drying value.

By virtue of this combination of features, and in particular by virtue of the independent activation of the thermal energy generation means and the air circulation means of each drawer module, the above method and oven allow flexographic plates to be dried in a more efficient and ecological way by significantly reducing the waste of electrical energy both during downtime and during the actual drying process.

Furthermore, by optimizing energy efficiency, an oven as disclosed herein substantially reduces the operating costs of the entire drying process and maintenance of the drying oven. In fact, the independent activation of the active devices (i.e. the thermal energy generation means and the air circulation means in each drawer module) allows the use of the smallest possible amount of energy to dry the flexographic plates and preserves the functionality of the devices themselves, delaying failure and consequent replacement thereof.

For the purposes of the present disclosure, by the term drying is meant the operation necessary to achieve a uniform and perfectly calibrated thickness of the flexographic plate downstream of the washing step. The purpose of drying is therefore to completely evaporate a washing solution, so that the flexographic plate subjected to drying has again a thickness exactly equal to that of the original plate, i.e. the plate upstream of the washing step.

### BRIEF DESCRIPTION OF THE SEVERAL VIEWS OF THE DRAWINGS

Further features and advantages of the present invention will become more apparent from the following detailed description of preferred, but not exclusive, embodiments thereof, presented below by way of non-limiting example with the aid of the accompanying drawings. In the drawings:

FIG. 1 schematically shows a perspective view of an oven for drying flexographic plates according to an embodiment as disclosed herein;

FIG. 2 schematically shows a perspective view, taken from another observation point, of the oven in FIG. 1, with one drawer open;

FIG. 3 schematically shows a perspective view, taken from yet another observation point, of the oven of FIG. 1, with side closing panels removed to reveal the internal components of the oven;

FIG. 4 schematically shows a perspective view of a heating unit of each drawer module of the oven in FIG. 1;

FIG. 5 is a flow chart, illustrating the various steps of a method for drying flexographic plates according to an embodiment as disclosed herein;

FIG. 6 is a flow chart of a control process implemented by a control unit of an oven according to an embodiment as disclosed herein;

FIGS. 7 and 8 are schematic views of an oven according to an embodiment as disclosed herein.

The same reference numbers and letters in the figures identify the same elements or components.

### DETAILED DESCRIPTION

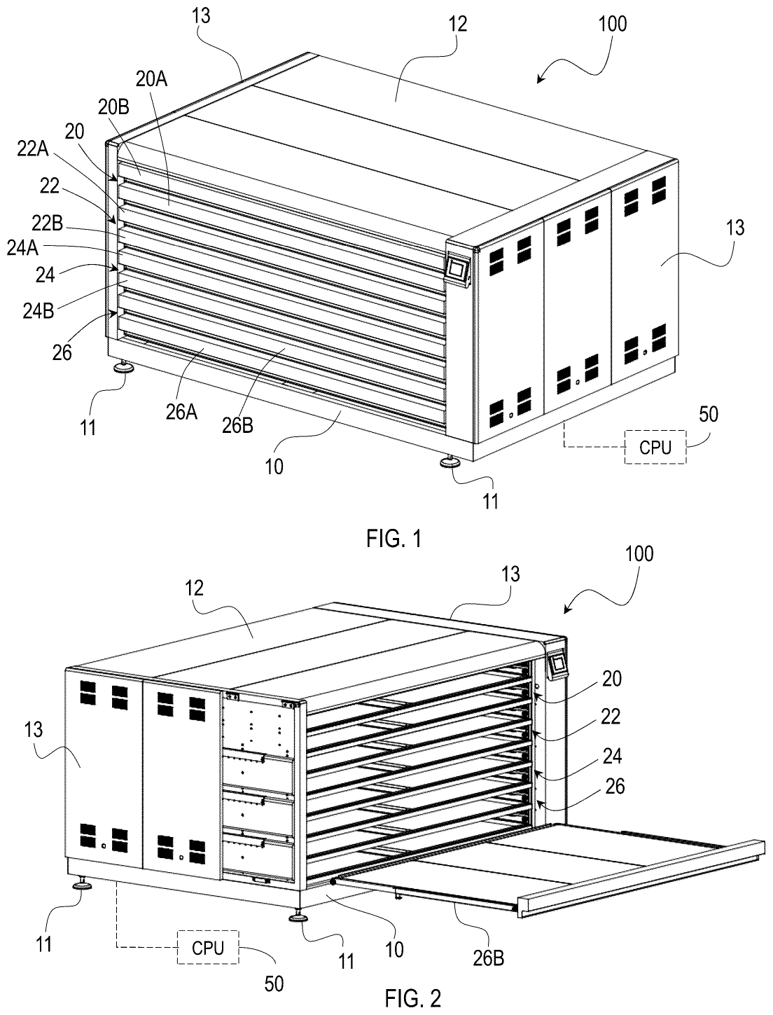

With reference to FIGS. 1 to 3, they schematically illustrate an oven for drying flexographic plates to which a method for drying flexographic plates according to the invention is applicable. In particular, the oven and the method as disclosed herein are provided for drying flexographic plates after their washing (with water or solvent) in order to remove the washing solution absorbed during the washing process. Hence, the oven and the method are provided for drying flexographic plates before their use in a printing process.

The oven, generally indicated with the reference numeral 100, comprises a base 10, preferably supported by feet 11, an upper closing panel 12 and side closing panels 13. Between the base 10 and the upper closing panels 12 and the side panels 13 there is a space inside which at least two drawer modules are housed.

In the embodiment illustrated in FIGS. 1 to 3, the drying oven 100 (or oven 100) comprises four drawer modules, namely a first drawer module 20, a second drawer module 22, a third drawer module 24, and a fourth drawer module 26. Of course, it is possible to provide a number of drawer modules greater than four, for example five drawer modules, i.e. ten drawers in total, as in large drying ovens, in which case the energy savings achieved will be exponentially greater.

Each drawer module 20, 22, 24, 26 comprises a pair of drawers, respectively 20A, 20B, 22A, 22B, 24A, 24B, 26A, 26B, each of which is intended to contain and support a respective flexographic plate to be dried inside the oven 100. Each drawer module 20, 22, 24, 26 may also comprise a number of drawers greater than two.

The drawers 20A, 20B, 22A, 22B, 24A, 24B, 26A, 26B of each drawer module 20, 22, 24, 26 are movable between a closed position, in which they are entirely housed in the housing space of the drawer module, and an open position, in which they are extracted from the housing space of the drawer module 20, 22, 24, 26.

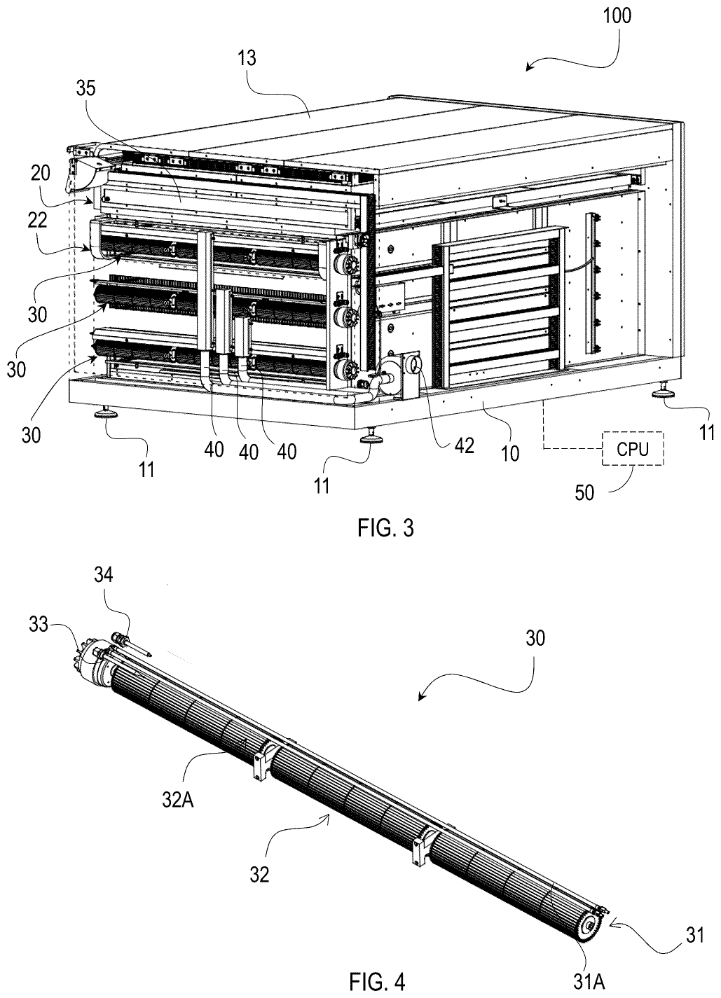

As visible in FIG. 3 and shown in detail in FIG. 4, each drawer module 20, 22, 24, 26 is provided with a heating unit 30, housed in the space housing the drawer modules of the drying oven 100, at the respective drawer module.

Each heating unit 30 comprises thermal energy generation means 31 adapted to convert electrical energy into thermal energy, and air circulation means 32 adapted to uniformly distribute the temperature inside each pair of drawers 20A, 20B, 22A, 22B, 24A, 24B, 26A, 26B of the respective drawer module 20, 22, 24, 26. In the illustrated embodiment, the thermal energy generation means 31 preferably consists of a pair of electrical resistors (indicated by reference numeral 31A), more preferably quartz electrical resistors, and the air circulation means 32 preferably consists of tangential fans (indicated by reference numeral 32A).

Each heating unit 30 also comprises at least one temperature probe 33 and, preferably, a safety thermostat 34.

The drying oven 100 further comprises, for each drawer module 20, 22, 24, 26 (and therefore for each corresponding pair of drawers) an extraction duct 40 for fumes generated inside the respective drawer module 20, 22, 24, 26 during the heating of the flexographic plates present inside the drawers 20A, 20B, 22A, 22B, 24A, 24B, 26A, 26B. Each fume extraction duct 40 is therefore connected to a single pair of drawers 20A, 20B, 22A, 22B, 24A, 24B, 26A, 26B.

The oven 100 further comprises fume extraction means 42, in fluid communication with the fume extraction ducts 40. In the illustrated embodiment, the fume extraction means 42 consist of a fan driven by a motor and common to all the fume extraction ducts 40. However, alternatively, it is possible to provide fume extraction means 42 for each fume extraction duct 40.

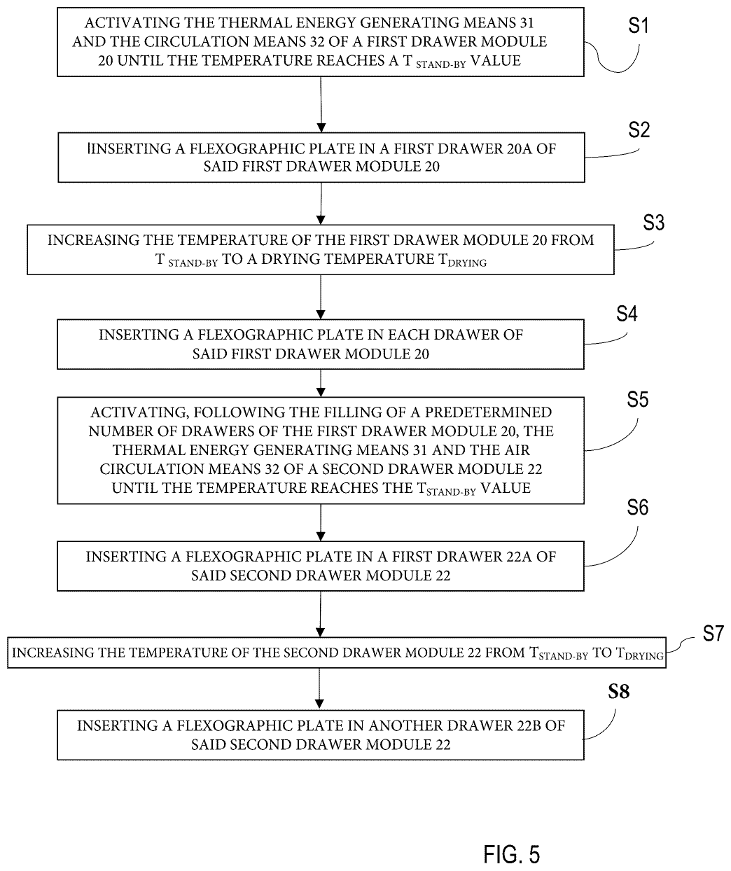

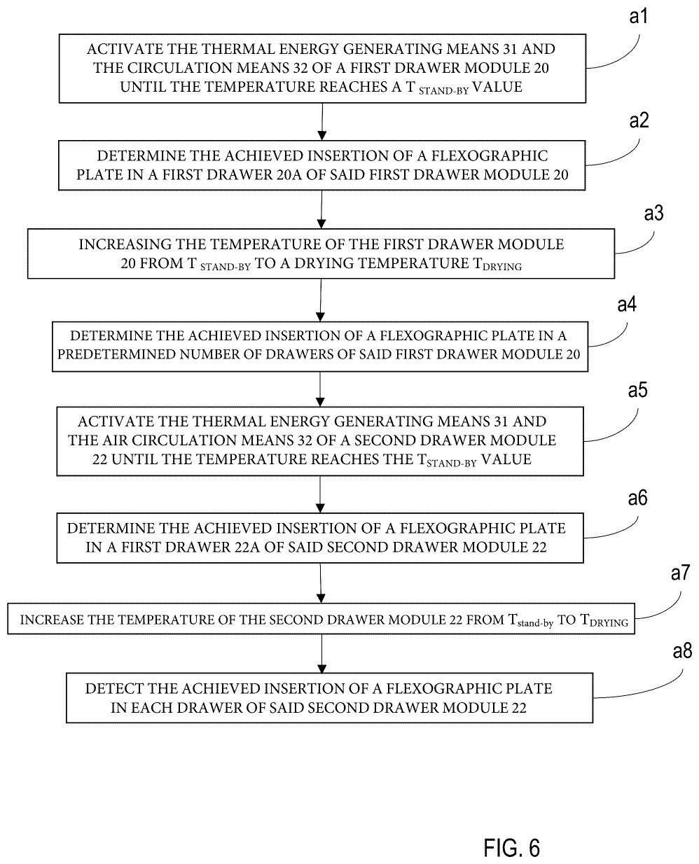

With reference to FIG. 5, an embodiment of a drying method according to the present disclosure is described below. Such method comprises a step S1 of activating the thermal energy generation means 31 and the air circulation means 32 of a first drawer module 20 of the oven, until the temperature of the first drawer module (i.e. of both drawers thereof) reaches an inactivity or stand-by value T_{stand-by}.

The method as disclosed herein may comprise a second step S2, subsequent to step S1, which involves inserting a flexographic plate into the first drawer 20A of the first drawer module 20.

The method as disclosed herein may comprise a step S3, subsequent to step S2, which involves activating the means 31 for generating thermal energy of the first drawer module 20 in order to increase the temperature thereof to a drying or working value T_{drying}. Therefore, according to the present disclosure, the temperature of the first drawer module 20 is increased to the working value T_{drying} only after the beginning of the filling of the drawer module itself. It follows that as long as no flexographic plate is inserted in the first drawer module, the latter is maintained at the T_{stand-by} temperature.

The drying temperature value T_{drying} may vary depending on the nature (material) of the flexographic plate. According to a possible implementation, for example, the value of the stand-by temperature T_{stand-by} may be comprised in a range between 80% and 90% of the drying temperature T_{drying}.

The method comprises the step S4 of inserting a flexographic plate into each other drawer of the first drawer module 20 until all drawers thereof are filled. Therefore, if the first drawer module 20 only includes two drawers, the step S4 will be completed when the second drawer 20B is filled. If the first drawer module 20 included four drawers, step S3 would be completed when the fourth drawer 20D of the drawer module itself is filled.

The method according to the present disclosure may also comprise step S5 which involves activating the thermal energy generation means 31 and the air circulation means 32 of the second drawer module 22 of the oven 100 until the temperature of the latter (i.e. the temperature of all its drawers 22A, 22B, 22C, 22D) reaches a stand-by value T_{stand-by}. In particular, step S5 is implemented after a predetermined number of drawers have been filled, i.e. after a flexographic plate has already been inserted into a predetermined number of drawers.

Preferably, step S5 is implemented when all drawers of the first drawer module 20 have been filled.

In the case where the first drawer module 20 comprises two drawers, step S5 is therefore implemented following the insertion of a flexographic plate in the second drawer 20B of the first drawer module 20 (completion of step S4). Imagining that the first drawer module comprises, e.g., three drawers, then step S5 may preferably be implemented following the insertion of a flexographic plate into the third drawer (i.e. the last drawer) after a flexographic plate has already been inserted into the second drawer 20B.

In any case, the method according to the present disclosure may provide, through step S5, for preheating the second drawer module 22 up to the inactivity or stand-by value T_{stand-by} only when the first drawer module 20 is partially filled or more preferably completely filled.

Step S5 is followed by step S6 which involves inserting the flexographic plate into a first drawer 22A of the second drawer module 22. In practice, in step S6 the filling of the drawers of the second drawer module 22 begins.

Step S6 is immediately followed by step S7 which involves acting on the thermal energy generation means 31 of the second drawer module 22 (i.e. reactivating them) so as to increase the temperature thereof to the drying value T_{drying}. Following step S7, all drawers 22A, 22B of the second drawer module 22 are brought to the drying temperature T_{drying}.

Step S7 may be followed by step S8 which involves inserting a flexographic plate into a second drawer of the second drawer module 22 and into any other drawer of the second drawer module 22, until the latter is filled.

In the event that the oven 100 includes more than two drawer modules, to activate the third drawer module 24 (following the second drawer module 22), the method involves operating according to steps similar to the steps S5 and S7 described above. Considering an oven with three drawer modules 20, 22, 24, following step S7, the flexographic plates are inserted into the other drawers of the second drawer module 22. When a predetermined number of drawers of the second drawer module 22 (preferably all of them) are filled, then the third drawer module 24 is brought to the inactivity or stand-by temperature T_{stand-by} by activating the thermal energy generation means 31 and the corresponding air circulation means 32 of the third drawer module 24 itself. Subsequently, following the insertion of a flexographic plate into a first drawer of the third drawer module 24, the temperature of the latter is brought to the drying or working value T_{drying}.

Experimental tests have shown that, using the control method according to the present disclosure in an oven with three drawer modules (and a total of six drawers, two for each drawer module):
from the moment the oven is turned on, and for the entire time of inactivity or stand-by, an energy saving of approximately 70% is achieved compared to traditional drying ovens which provide for the simultaneous heating of all the drawer modules to the drying temperature;
when a flexographic plate is inserted into the first drawer 20A of the first drawer module 20, and the temperature of the first drawer module is brought from the inactivity or stand-by temperature T_{stand-by} to the drying or working temperature T_{drying} and the fume extraction means are activated, the energy saving is approximately 60% compared to traditional drying ovens; and
when a flexographic plate is inserted into the second drawer 20B of the first drawer module 20 and the electrical resistors 31A and the air circulation fans 32A of the second drawer module 20B are activated, by controlling the operation of the electrical resistors 31A on the basis of the stand-by temperature T_{stand-by}, the energy saving is approximately 35/40% compared to traditional drying ovens (depending on the external environmental conditions).

According to an embodiment thereof, the method as disclosed herein provides for activating the fume extraction means 42 of a respective drawer module 20, 22 of the oven 100 following the insertion of a flexographic plate into the first drawer 20A, 22A of the same drawer module. Therefore, the fume extraction means 42 of the first drawer module 20, for example, are activated at the same time or after the implementation of step S3, whereas the suction means 42 of the second drawer module 22 will be activated at the same time or following the implementation of step S5 described above.

In general, the method as disclosed herein involves removing a flexographic plate from the drawer (of a corresponding drawer module 20, 22) into which it was previously inserted after a predetermined drying interval or period, the duration of which will depend on the material constituting the flexographic plate.

In this regard, it is likely that, keeping the drying period the same, the flexographic plates inserted in the first drawer module 20 will be removed before those inserted in the subsequent drawer modules 22, 24, 26. According to an embodiment thereof, the method as disclosed herein provides for inserting a plate into a drawer of a drawer module, different from the first drawer module, only if the drawers of a preceding drawer module are completely filled. Considering, for example, the two drawer modules 20, 22, according to this embodiment, step S6 and step S8 indicated above are implemented only when all of the drawers of the first drawer module 20 are filled upon completion of step S5 and S7 respectively.

For example, if, upon completion of step S5, a drawer of the first drawer module (probably the first drawer 20A) is empty following the extraction of the dried flexographic plate from it, then step S6 is not carried out and the flexographic plate to be dried is inserted into the empty drawer of the first drawer module 20. Similarly, if following step S7, a drawer of the first drawer 20 is empty (i.e. without a flexographic plate inserted in it), then step S8 is not carried out and the plate to be dried is inserted into the empty drawer of the first drawer module 20.

This solution allows the implementation of step S7 to be “delayed”, and therefore further energy savings to be achieved. At the same time, priority is always given to the first drawer module 20 in order to limit the use of the second drawer module 22 as much as possible.

In a possible embodiment thereof, the method provides for deactivating the thermal energy generation means 31 and the air circulation means 32 of the second drawer module 22 when all the flexographic plates have been removed (or in any case already dried) from the same and when a predetermined number of drawers of the first drawer module 20 are free. More generally, a drawer (for example the third one) is deactivated when it no longer contains plates to be dried and when one or more drawers of a preceding drawer module (the first drawer module or the second drawer module) are empty. This solution allows gradually turning the oven off, always to the benefit of energy saving.

Preferably, the method involves deactivating the fume extraction means 42 of a drawer module after a predetermined time interval from the deactivation of the heat generation means 31 and the air circulation means 32 of the same drawer module.

The drying oven 100 further comprises an electronic control unit or CPU 50, which uses electronic technology for autonomously monitoring and controlling the oven's functions. To this end, the CPU 50 is in electrical communication with the thermal energy generation means 31 and the air circulation means 32 of the heating unit 30 and with the fume extraction means 42 of each drawer module 20, 22, 24, 26. The thermal energy generation means 31, the air circulation means 32 and the fume extraction means 42 in fact constitute the active devices of the drawer modules of the drying oven 100.

More specifically, the CPU 50 is specially provided with specific software for precise control of the aforementioned active devices of each drawer module 20, 22, 24, 26 via electronic interfaces (not shown) with analogue or digital inputs and outputs.

More specifically, the CPU 50 is configured to activate/deactivate the electrical resistors 31A (i.e. the thermal energy generation means 31), the tangential fans 32 (i.e. the air circulation means 32) and/or the fume extraction fan 42A (i.e. the fume extraction means 42) of each drawer module 20, 22, 24, 26, independently from the other drawer modules. In other words, the CPU activates/deactivates the heat generation means 31 and/or the air circulation means 32 and/or the fume extraction means 42 of a drawer module without such activation/deactivation determining an activation/deactivation of corresponding means of another drawer module. Therefore, the means (31, 32, 42) of a drawer module may be activated simultaneously or not as the means (31, 32, 42) of another drawer module.

In the embodiment illustrated in the figures, the CPU 50 may be implemented either using boards designed and built specifically for the specific application or using commercial products such as industrial PCs and PLCs (Programmable Logic Controllers).

In this specific case, the control software has the purpose of managing the active devices, specifically the thermal energy generation means 31, the air circulation means 32 and/or the fume extraction means 42, of each drawer module 20, 22, 24, 26 from the moment in which the oven 100 is turned on until the moment in which it is turned off or turns off automatically.

With particular reference to the thermal energy generation means 31 of the heating unit 30 of each drawer module 20, 22, 24, 26, during operation of the oven 100, the CPU 50 detects the temperature inside the drawers 20A, 20B, 22A, 22B, 24A, 24B, 26A, 26B through the temperature probe 33 and increases or decreases the time of application of voltage to one or both of the electrical resistors 31A of the pair of electrical resistors until a preset temperature (e.g. T_{standby} or T_{drying}) is reached.

The CPU 50 of the oven 100 according to the present disclosure is configured to implement the following control procedure:
a1) activating the thermal energy generation means 31 and the air circulation means 32 of a first drawer module 20 of the oven 100 until the temperature of the first drawer module 20 reaches an inactivity or stand-by value (T_{standby});
a2) determining the achieved insertion of a flexographic plate into a first drawer 20A of the first drawer module 20;
a3) activating the thermal energy generation means 31 of the first drawer module 20 of the oven 100 so as to increase the temperature of the first drawer module 20 from the stand-by value to a drying or working value T_{drying};
a4) determining the insertion of a flexographic plate into a predetermined number of drawers of the first drawer module 20;
a5) activating the thermal energy generation means 31 and the air circulation means 32 of a second drawer module 22 of the oven 100 until the temperature of the second drawer module 22 reaches an inactivity or stand-by value T_{standby};
a6) determining the achieved insertion of a flexographic plate into a first drawer of the second drawer module (20);
a7) activating, following step a6), the thermal energy generation means 31 of the second drawer module 22 of the oven 100 so as to increase the temperature of the second drawer module 22 from the stand-by value to a drying or working value T_{drying}.

The CPU 50 is preferably configured so as to activate the fume extraction means 42 of the oven 100 at the same time as or after the activation of the thermal energy generation means 31 and the air circulation means 32 of the relative drawer module 20, 22.

Within steps al), a3), a5), and a7), the CPU 50 will send an activation signal to the corresponding heat generation means 31 and the corresponding air circulation means 32 to bring the temperature to the desired value. Upon reaching such temperature, the CPU 50 will send a deactivation signal following which the means will be turned off.

The oven 100 according to the invention may be configured to allow the CPU 50 to implement the control procedure in a semi-automatic manner. By the term “semi-automatic” it is meant a mode whereby the CPU 50 implements the above control procedure following at least one signal provided by an external operator.

With reference to step a1), the oven 100 is provided with at least one manually operable general interface device 110 electronically connected to the CPU 50. The latter therefore carries out step a1) following an electrical command signal generated by the general interface device 110. More precisely, following the signal sent by the general interface device 110, the CPU 50 sends an electrical activation signal to the generation means 31 and the circulation means 32 of the first drawer module 20.

By the term “general interface device 110” it is meant any device accessible to an operator to activate the oven 100 (i.e. to implement the first step a1). The general interface device 110 may consist of a button located on the oven 100 or even a remote device (for example a smartphone or a tablet, communicating via a wireless system with the CPU 50).

Still referring to step a1), the CPU 50, through timed current pulses, regulates the operation of the electrical resistors 31A and monitors in real time the temperature detected by the temperature probe 33, so as to bring the temperature of the drawers 20A, 20B of the first drawer module 20 to the stand-by temperature T_{stand-by}. Similarly, the CPU will control the operation of the resistors 31A to implement steps a3), a5) and a7) above.

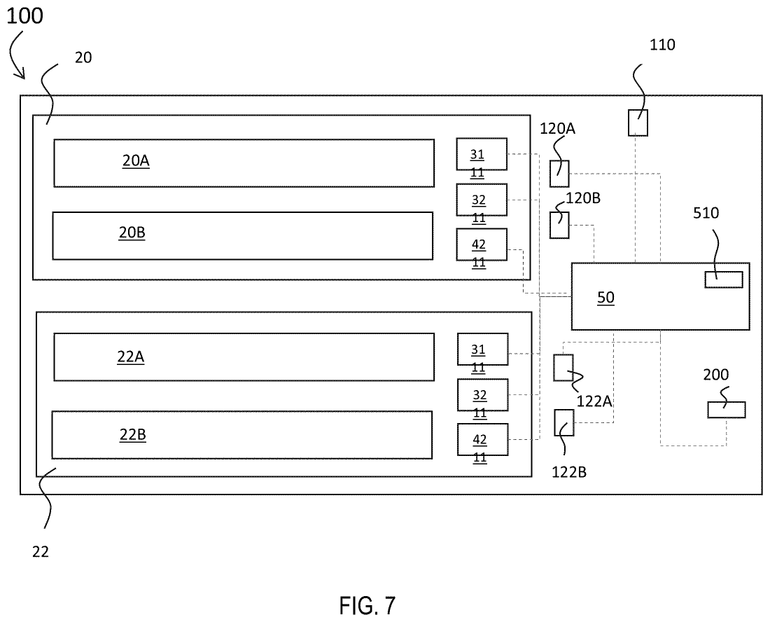

Referring as follows to FIG. 7, in a first embodiment, the oven 100 according to the present disclosure comprises a specific interface device 120A, 120B, 122A, 122B which may be operated manually for each drawer of each drawer module 20, 22. Each of these devices 120A, 120B, 122A, 122B is electrically connected to the CPU 50 to generate a control signal intended for the same. More precisely, each specific interface device 120A, 120B, 122A, 122B is intended to be manually operated by an operator after the latter has inserted a flexographic plate into the relevant drawer. Upon receipt of the control signal, the CPU 50 establishes that the flexographic plate has been inserted into the drawer 20A, 20B, 22A, 22B to which the interface device 120A, 120B, 122A, 122B is associated. At the same time, upon receipt of the control signal, the CPU activates its own timer module 510 for counting the drying time of the flexographic plate.

Following receipt of the control signal sent by the interface device 120A associated with the first drawer 20A of the first drawer module 20, according to step a2), the CPU 50 determines the insertion of the flexographic plate into the same first drawer 20A. Consequently, the CPU 50 implements step a3), i.e. it sends a control signal to the generation means 31 following which the temperature of the first drawer module 20 is brought to the working value T_{drying}.

In general, following the control signal sent by the interface device 120B, associated with the second drawer 20B of the first drawer module 20, the CPU 50 establishes that a flexographic plate has been inserted into the same predetermined drawer (step a4 indicated above) and consequently carries out step a5) i.e. it sends a control signal to the generation means 31 and to the circulation means 32 of the second drawer module 22 following which the temperature of the same is brought to the inactivity value T_{stand-by}.

Following receipt of the control signal sent by the interface device 122A associated with the first drawer 22A of the second drawer module 22, according to step a2), the CPU 50 determines the insertion of the flexographic plate into the same first drawer. Consequently, the CPU 50 carries out step a7), i.e. it sends a control signal to the thermal energy generation means 31 of the second drawer module 22 following which the temperature of the same is brought to the working value T_{drying}.

The oven 100 is preferably provided with signalling means 200 for generating a signal indicating the end of the drying period of a flexographic plate in a predetermined drawer. Such signalling means 200 are connected to the CPU 50. The latter sends an activation signal to the signalling means 200. Such activation signal is generated by the CPU 50 when it receives a signal emitted by a timer module 510 indicating the completion of the predetermined drying period.

The signalling means 200 indicated above may be of a visual and/or acoustic type. In one embodiment thereof, the signalling means 200 may be installed on the oven 100 and may comprise a light and/or acoustic indicator for each drawer of each drawer module. The activation of a light indicator indicates to the operator that the drying of the plate contained in the corresponding drawer is completed.

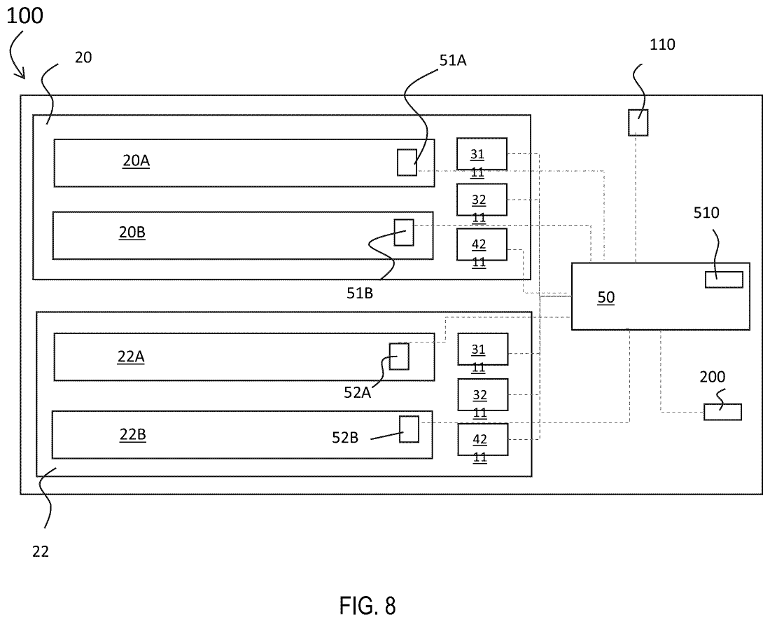

Referring to FIG. 8, in an alternative embodiment, the oven 100 may be configured to enable the CPU 50 to implement the above-described control procedure according to the present disclosure in a substantially automatic manner. In this regard, for each drawer of each drawer module, the oven 100 may comprise a sensor means 51A, 51B, 52A, 52B electrically connected to the CPU 50. In particular, each sensor means sends to the CPU 50 a signal indicating the insertion (and therefore the presence) or removal (and therefore the absence) of a flexographic plate from the corresponding drawer. Upon receiving this signal, the CPU 50 then determines the insertion or removal of the flexographic plate from a corresponding drawer.

In a possible embodiment thereof, the sensor means 51A, 51B, 52A, 52B may be configured to detect the opening and closing of the corresponding drawer. The CPU 50 may determine, for example, the insertion or removal of the plate, for example, following the receipt of two sequential signals generated by the sensor means 51A, 51B, 52A, 52B, one indicating the opening and the other indicating the closing of the relevant drawer.

In one embodiment, the sensor means 51A, 51B, 52A, 52B may be defined by a “position” sensor that detects the presence or absence of the plate in the relative drawer, and generates, for each of the two conditions, a corresponding signal that is sent to and processed by the CPU 50. The use of a single sensor may be contemplated, for example, when the plate is inserted and removed from a drawer at the same side of the drawer itself, as in the case of oven 100 shown in FIGS. 1 to 4. Instead, if the flexographic plate is removed on a side other than the one on which it is inserted, then the sensor means may comprise two position sensors: a first sensor positioned close to the plate insertion side and a second sensor positioned close to the plate removal side. The first sensor has the function of generating a signal indicating the insertion/entry of the plate into the drawer, while the second sensor has the function of generating a signal indicating the removal/exit of the plate from the same drawer.

Preferably, the CPU 50 is configured to turn off the heat generation means 31 and the air circulation means 42 of all the drawer modules 20, 22 following a control signal transmitted through the manually operable general interface device 110. Basically, following a control signal sent through the general interface device 110, the CPU 50 sends a signal to the heat generation means 31 and a signal to the air circulation means 42 following which such means 31, 42 are deactivated.

Preferably, the CPU 50 is configured to deactivate the fume extraction means (fans 42) of a drawer module after a predetermined time interval from the deactivation of the heat generation means 31 and the air circulation means 32. In other words, the CPU 50 sends a deactivation signal to the fume extraction means 42 delayed by a predetermined time interval with respect to the deactivation signal sent to the heat generation means 31 and to the air circulation means 32 of the drawer modules.

In an embodiment, the CPU 50 may be configured to check, at the end of step a5) and/or at the end of step a6), the presence of a plate in each of the drawers of the first drawer module 20. Only if this is the case (i.e. if there is a plate in all drawers of the first drawer module 20), the CPU 50 carries out the step a7) indicated above. This embodiment leads to energy savings as the heat generation means 31 of the second drawer module 22 are activated only when the first drawer module 20 is filled.

In one possible embodiment, the CPU 50 deactivates the devices of the second drawer module 22 if it establishes that at least one drawer 20A of the first drawer module 20 is empty and at the same time that no plate is inserted in the second drawer module 22.

More generally, in the case in which the oven 100 comprises two or more drawer modules, preferably, the CPU 50 is configured so as to determine the absence of a plate in the first drawer 20A of the first drawer module 20 and the simultaneous presence of one or more unused drawer modules, i.e. the absence of a plate in any drawer of a same drawer module 22, 24. When this condition occurs, the CPU 50 deactivates the heat generation means 31 and the air circulation means 32 of the unused drawer modules. In this way, only the drawer modules containing plates undergoing drying are kept active (in terms of heat generation and air circulation). In practice, the deactivation of the active devices of the drawer modules occurs as the flexographic plates are removed from the respective drawers. This additional embodiment allows for gradual shutdown of the oven and therefore further energy savings.

From the above description, the features of the oven for drying flexographic plates and of the relative control method, according to the present disclosure, as well as the corresponding advantages, are apparent. In particular, the drying oven and the corresponding control method allow the flexographic plates to be dried while reducing energy waste, preserving the functionality of the active and passive devices for the longest possible time and, therefore, substantially reducing both the operating costs and the maintenance costs of the oven.

Finally, it is clear that the flexographic plate drying oven thus conceived is susceptible to numerous modifications and variations; furthermore, all the details may be replaced by technically equivalent elements.

What is claimed is:

1. A method for drying flexographic plates using an oven comprising at least two drawer modules, each drawer module comprising a respective heating unit that includes thermal energy generation means and air circulation means, the method comprising:
S1) activating the thermal energy generation means and the air circulation means of a first drawer module of the oven, until the temperature of the first drawer module reaches a stand-by value;
S2) inserting a flexographic plate into a first drawer of the first drawer module;
S3) increasing the temperature of the first drawer module from the stand-by value to a drying value;
S4) inserting a flexographic plate into each drawer of the first drawer module subsequent to the first drawer until all drawers of the first drawer module are filled;
S5) activating, after a predetermined number of drawers of the first drawer module has been filled with a flexographic plate, the thermal energy generation means and the air circulation means of a second drawer module of the oven until the temperature of the second drawer module reaches a stand-by value;
S6) inserting a flexographic plate into a first drawer of the second drawer module;
S7) increasing the temperature of the second drawer module from the stand-by value to a drying value.

2. The method of claim 1, wherein the step (S7) is carried out after all the drawers of the first drawer module have been filled with a flexographic plate to be dried.

3. The method of claim 1, further comprising a step (S8) of inserting a flexographic plate to be dried into a drawer of the second drawer module, different from the first drawer.

4. The method of claim 1, comprising a step of removing a flexographic plate from a respective drawer at the end of a predetermined drying period.

5. The method of claim 3, wherein the step (S8) is carried out if, at the end of the step (S7), a flexographic plate is inserted into each of the drawers of the first drawer module.

6. The method of claim 5, wherein, when, at the end of step (S7), at least one of the drawers of the first drawer module is empty, the method comprises a step of inserting a flexographic plate in the empty drawer of the first drawer module.

7. The method of claim 1, comprising deactivating the thermal energy generation means and the air circulation means of the second drawer module of the oven when all drawers thereof are empty and when at least one drawer of the first drawer module is empty.

8. The method of claim 1, wherein the oven further comprises, for each of the drawer modules, fume extraction means and wherein the method, simultaneously with or subsequent to the steps (S3) and (S7), comprises activating the fume extraction means of a respective drawer module.

9. The method of claim 8, comprising deactivating the thermal energy generation means and the air circulation means of the second drawer module of the oven when all drawers thereof are empty and when at least one drawer of the first drawer module is empty.

10. The method of claim 9, comprising deactivating the fume extraction means after a predetermined time period from the deactivation of the thermal energy generation means and of the air circulation means of the second drawer module.

11. An oven for drying flexographic plates comprising:
at least two drawer modules, each comprising a respective heating unit including thermal energy generation means and air circulation means; and
an electronic control unit in electrical communication with the thermal energy generation means and the air circulation means of each drawer module, wherein the electronic control unit is configured to:
activate the thermal energy generation means and the air circulation means of a first drawer module of the oven, until the temperature of the first drawer reaches a stand-by value;
determine the achieved insertion of a flexographic plate in a first drawer of the first drawer module;
activate the generation means of the first drawer module so as to increase the temperature of the first drawer module from the stand-by value to a drying value;
determine the achieved insertion of a flexographic plate for each drawer of the first drawer module;
activate, following the determination of the achieved insertion of a flexography plate in a predetermined number of drawers of the first drawer module, the thermal energy generation means and the air circulation means of a second drawer module of the oven until the temperature of the second drawer module reaches a stand-by value;
determine an achieved insertion of a flexographic plate in a first drawer of the second drawer module;
activate the heat generation means of the second drawer module so as to increase the temperature of the second drawer module from the stand-by value to a drying value.

12. The oven of claim 11, further comprising fume extraction means in electrical communication with the electronic control unit, wherein the electronic control unit is configured to activate the fume extraction means simultaneously with or subsequent to the activation of the thermal energy generation means and the air circulation means of each drawer module.

13. The oven of claim 11, comprising a general interface device manually operable and electrically connected to the electronic control unit, wherein the electronic control unit is configured to activate the thermal energy generation means and the air circulation means of the first drawer module of the oven following a signal generated by the general interface device.

14. The oven of claim 11, wherein, for each drawer of each drawer module, the oven comprises a further specific interface device manually operable and electrically connected to the electronic control unit, wherein the electronic control unit comprises a timer module which is activated following a signal generated by the specific interface device indicating that a flexographic plate has been inserted into a respective drawer.

15. The oven of claim 14, comprising warning means for generating a signal indicative of the end of a drying interval of a flexographic plate, wherein the warning means are electrically connected to the electronic control unit, and wherein the electronic control unit is configured to activate the warning means following a signal generated by the timer module.

16. The oven of claim 11, wherein, for each drawer of each drawer module, the oven includes one or more sensors configured to detect an insertion of a flexographic plate within the respective drawer, wherein the electronic control unit includes a timer module which is activated following a signal generated by the one or more sensors.

17. The oven of claim 16, comprising warning means for generating a signal indicative of the end of a drying interval of a flexographic plate, wherein the warning means are electrically connected to the electronic control unit, and wherein the electronic control unit is configured to activate the warning means following a signal generated by the timer module.
